(19) United States
(12) Patent Application Publication
(10) Pub. No.: US 2024/0103204 A1
(43) Pub. Date: Mar. 28, 2024

(54) LOW STATIC OPTICAL REMOVABLE LENS STACK

(71) Applicant: Racing Optics, Inc., Las Vegas, NV (US)

(72) Inventors: Stephen S. Wilson, Las Vegas, NV (US); Bart E. Wilson, Las Vegas, NV (US)

(21) Appl. No.: 18/474,860

(22) Filed: Sep. 26, 2023

Related U.S. Application Data
(63) Continuation of application No. 18/163,200, filed on Feb. 1, 2023, now Pat. No. 11,808,952.
(60) Provisional application No. 63/377,155, filed on Sep. 26, 2022.

(51) Int. Cl. G02B 3/00; A42B 3/20; G02B 1/16

(52) U.S. Cl. CPC G02B 3/0068; A42B 3/20; G02B 1/16

(57) ABSTRACT

A removable lens stack comprises a base layer including a substrate and an antistatic coating comprising quaternary ammonium cations on a first side of the substrate and one or more removable lens layers stacked on top of the base layer. Each removable lens layer may include a substrate, an antistatic coating comprising quaternary ammonium cations on a first side of the substrate, and an adhesive on a second side of the substrate opposite the first side. The one or more removable lens layers may be stacked on top of the base layer such that the second side of the substrate of each removable lens layer faces the first side of the substrate of an immediately preceding layer. Refractive indices of the substrate of the base layer, the substrate of each removable lens layer, and the adhesive of each removable lens layer may be matched (e.g., to within 0.2).

### CROSS-REFERENCE TO RELATED APPLICATIONS

This application is a continuation of U.S. application Ser. No. 18/163,200 filed Feb. 1, 2023, which relates to and claims the benefit of U.S. Provisional Application No. 63/377,155, filed Sep. 26, 2022 and entitled “LOW STATIC OPTICAL REMOVABLE LENS STACK,” the entire contents of which is expressly incorporated by reference.

### STATEMENT RE: FEDERALLY SPONSORED RESEARCH/DEVELOPMENT

Not Applicable

### BACKGROUND

Current optical removable lens stacks, such as those currently manufactured by Racing Optics, Inc. of Las Vegas, Nevada, the disclosure of which is expressly incorporated herein by reference, have become the industry standard for vision and surface protection. One industrial area where such lens stacks have not been widely used is in sand blasting applications. Sand blasters wear protective helmets with a rigid face shield. Their face shield becomes abraded very quickly and vision is impaired. Ideally, they would incorporate current removable lens stacks to the face shield and remove one layer from the stack when their vision is impaired. However, it has been found that when you remove one layer from the stack, static electricity is generated and particles in the air stick to the remaining lens stack surface and face shield. Each time an outer layer is removed from the lens stack, more static electricity is generated and released. Static electricity must be eliminated in order for conventional lens stacks to be effectively used in sand blasting and in other industrial and medical environments where a static charge is not wanted.

Static electricity is the name given to a build-up of electrical charges on the surface of insulators (poor conductors of electricity). It is a surface phenomenon and occurs when two or more surfaces come in contact with each other and then are separated. These electrical charges are then released when each lens layer is removed. Polymers/plastics tend to have a negative charge. Air and skin tend to be positively charged. Surfaces with like polarity repel from each other. Surfaces with different polarity attract to each other. This is why you feel a static shock when removing two pieces of plastic from each other. The negative ions jump to the closest positive ions in the air and on your skin.

### BRIEF SUMMARY

The present disclosure contemplates various systems and methods for overcoming the above drawbacks accompanying the related art. One aspect of the embodiments of the present disclosure is a removable lens stack. The removable lens stack may comprise a base layer including a substrate and an antistatic coating comprising quaternary ammonium cations, the antistatic coating being provided on a first side of the substrate. The removable lens stack may further comprise one or more removable lens layers stacked on top of the base layer, each removable lens layer including a substrate, an antistatic coating comprising quaternary ammonium cations, and an adhesive, the antistatic coating being provided on a first side of the substrate and the adhesive being provided on a second side of the substrate opposite the first side. The one or more removable lens layers may be stacked on top of the base layer such that the second side of the substrate of each removable lens layer faces the first side of the substrate of an immediately preceding layer from among the base layer and the one or more removable lens layers. Refractive indices of the substrate of the base layer, the substrate of each removable lens layer, and the adhesive of each removable lens layer may be matched to within 0.2.

Each removable lens layer may include an adhesive promoting treatment on the second side of the substrate between the substrate and the adhesive. Each removable lens layer may be corona treated on the second side of the substrate. The base layer may include an adhesive, the adhesive being provided on a second side of the substrate opposite the first side. The base layer may include an adhesive promoting treatment on the second side of the substrate between the substrate and the adhesive. The base layer may be corona treated on the second side of the substrate. The substrate of each removable lens layer may comprise a polyethylene terephthalate (PET) film or a thermoplastic polyurethane (TPU) film. The substrate of the base layer may comprise a PET film or a TPU film.

Another aspect of the embodiments of the present disclosure is a sand blasting helmet. The sand blasting helmet may comprise a face shield and one or more removable lens layers stacked on the face shield. Each removable lens layer may include a substrate, an antistatic coating comprising quaternary ammonium cations, and an adhesive, the antistatic coating being provided on a first side of the substrate and the adhesive being provided on a second side of the substrate opposite the first side. The one or more removable lens layers may be stacked on the face shield such that the second side of the substrate of a first of the one or more removable lens layers faces the face shield and the second side of the substrate of each removable lens layer after the first faces the first side of the substrate of an immediately preceding removable lens layer from among the one or more removable lens layers. Refractive indices of the substrate of each removable lens layer and the adhesive of each removable lens layer may be matched (e.g., to within 0.2).

Each removable lens layer may include an adhesive promoting treatment on the second side of the substrate between the substrate and the adhesive. Each removable lens layer may be corona treated on the second side of the substrate. The substrate of each removable lens layer may comprise a PET film or a TPU film.

Another aspect of the embodiments of the present disclosure is a method of manufacturing a removable lens stack. The method may comprise providing an antistatic coating on a first substrate, the antistatic coating comprising quaternary ammonium cations. The method may further comprise providing an adhesive on a second substrate and stacking the second substrate on the first substrate such that the adhesive provided on the second substrate faces the antistatic coating provided on the first substrate. Refractive indices of the first substrate, the second substrate, and the adhesive may be matched (e.g., to within 0.2).

The method may comprise providing an adhesive promoting treatment on the second substrate prior to providing the adhesive. The method may comprise corona treating the second substrate prior to providing the adhesive. The first and/or second substrate may comprise a PET film or a TPU film.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a removable lens stack applied to a face shield of a sandblasting helmet in accordance with an embodiment of the present disclosure;

FIG. 2 is a cross-sectional view of the removable lens stack and face shield taken along the line 2-2 in FIG. 1;

FIG. 3 is another cross-sectional view of the removable lens stack and face shield in which an outermost layer of the removable lens stack is being peeled off; and

FIG. 4 is an example operational flow according to an embodiment of the present disclosure.

### DETAILED DESCRIPTION

The present disclosure encompasses various embodiments of a removable lens stack that is affixable to or usable as a face shield of a sandblasting helmet, along with methods of manufacture and use thereof. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that relational terms such as first and second and the like are used solely to distinguish one from another entity without necessarily requiring or implying any actual such relationship in order between such entities.

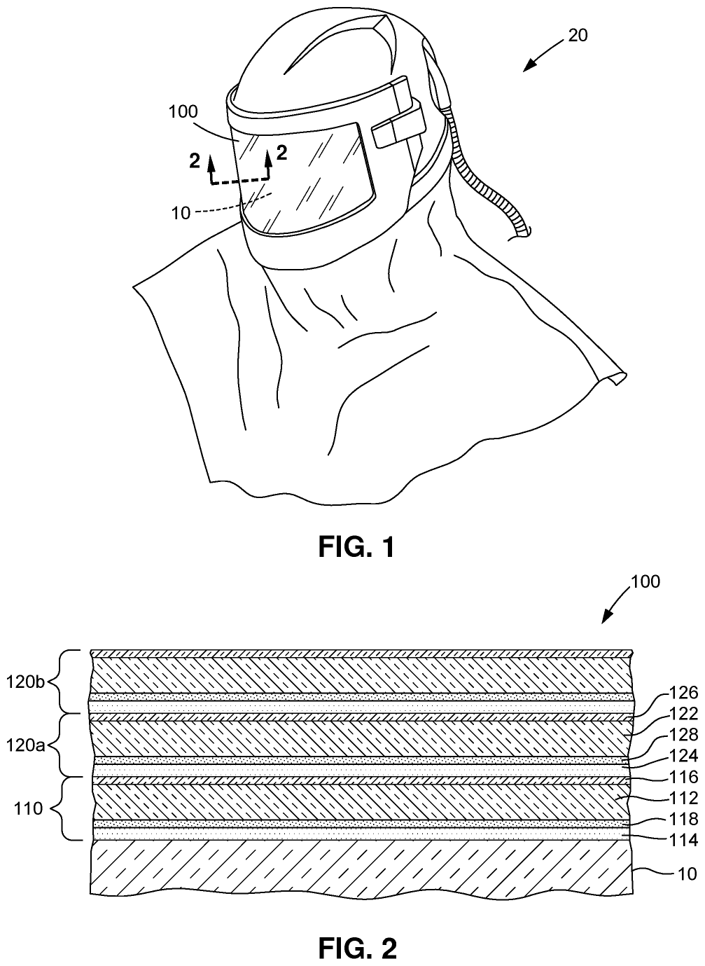

FIG. 1 shows a removable lens stack 100 applied to a face shield 10 of a sandblasting helmet 20 in accordance with an embodiment of the present disclosure, with FIG. 2 being a cross-sectional view thereof. The removable lens stack 100 may include a base layer 110 that may be affixed (e.g., mechanically or with adhesive) to the face shield 10 or other surface such as a goggle lens or visor or a transparent window of a helmet, hood, or gown, for example, especially those for use in sandblasting or other activities that would benefit from avoiding the buildup of static electricity. Alternatively, the base layer 110 of the removable lens stack 100 may itself serve as the lens, visor, face shield, or other surface, e.g., by being attached at a perimeter thereof to a frame of the helmet, hood, gown, goggle, or other article. Stacked on top of the base layer 110, the removable lens stack 100 may further include one or more removable lens layers 120a, 120b, etc. (collectively 120), each comprising a substrate 122 such as a polyethylene terephthalate (PET) or thermoplastic polyurethane (TPU) film, for example, and an adhesive 124 for adhering the removable lens layer 120 to the previous adhesive lens layer 120 (or, in the case of the innermost removable lens layer 120, to the base layer 110). As debris accumulates on the outermost removable lens layer 120 during sandblasting or other activities, or as the layer 120 becomes pitted or otherwise damaged, the wearer may simply tear it off to reveal the next pristine lens layer 120 (or base layer 110) underneath. Depending on the number of removable lens layers 120 in the stack, the process may be repeated several times before replacing the stack 100.

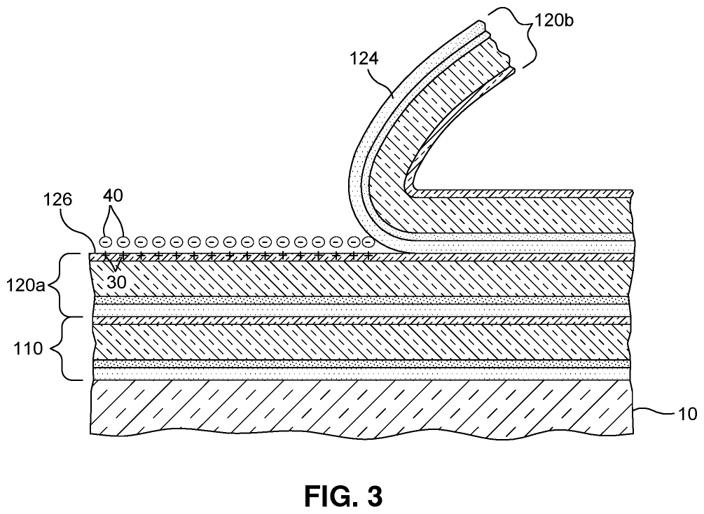

FIG. 3 is another cross-sectional view of the removable lens stack 100 and face shield 10 in which an outermost layer 120b of the removable lens stack 100 is being peeled off. In order to prevent the buildup of static electricity that might otherwise result from the peeling off of each removable lens layer 120, each removable lens layer 120 may further include an antistatic coating 126 as shown in FIGS. 2 and 3. The antistatic coating 126 may comprise positively charged ions 30, e.g., polyatomic ions such as quaternary ammonium cations (QAC), which may be dispersed in an acrylic or urethane polymer, for example. By embedding positive ions in the mating surface between layers in this way, the static electricity caused by the separation of the negatively charged (typically plastic) lenses 122 may be neutralized. As illustrated in FIG. 3, for example, the antistatic coating 126 of the removable lens layer 120a that is to remain on the stack 100 comes in direct contact with the removable adhesive 124 of the removable lens layer 120b that is being peeled off. The positive ions 30 embedded in the antistatic coating 126 attract negative ions 40 that are released from the removable lens layer 120b when the layers 120 are peeled apart. Whereas the negative ions 40 would normally create a net negative charge on the remaining removable lens layer 120a, resulting in an undesired attraction of dust and debris from the air, the negative ions 40 are instead attracted to and neutralized by the positive ions 30 of the remaining removable lens layer 120a. In this way, most, if not all, of the charge may be completely eliminated when a layer 120 is removed from the stack 100, allowing for a static-free embodiment for sandblasting or other activity where static buildup is undesirable.

In addition to the antistatic coating 126, various other surface treatments may be applied to the removable lens layers 120, typically in the form of very thin coatings that help promote an outcome on a surface of the lens layer 120. Of particular use in the context of the disclosed removable lens stack 100, each removable lens layer 120 may further include an adhesive promoting treatment 128 between the substrate 122 and the adhesive 124. The adhesive promoting treatment 128 may be a very thin (e.g., 5-10 nm) rough coat of acrylic or polyurethane, for example. Alternatively, the substrate 122 may undergo a corona treatment to promote adhesion. By promoting the adhesion of the substrate 122, it can be ensured that the adhesive 124 stays with the substrate 122 as a given layer (e.g., layer 120b) is removed from the layer underneath (e.g., layer 120a). Advantageously, this may prevent unwanted residue from transferring to the next layer 120, which could impair the vision of the sandblaster or other wearer of the lens stack 100. Such a clean removal may typically result in an increased buildup of static electricity, making the disclosed antistatic coating(s) 126 especially beneficial in the context of removable lens layers 120 that have been treated to promote adhesion.

Like the removable lens layers 120, the base layer 110 of the removable lens stack 100 may comprise a substrate 112 and antistatic coating 116 that may be the same as the substrate 122 and antistatic coating 126 of each removable lens layer 120. If the base layer 120 is to be affixed to a face shield 10 or other surface, the base layer 110 may further comprise an adhesive 114 (e.g., a self-wetting removable adhesive) and, optionally, an adhesive promoting treatment 118 that may be the same as the adhesive 124 and adhesive promoting treatment 128 of each removable lens layer 120. In order to keep optical distortion as low as possible, the refractive indices of the substrates 112, 122 and any adhesives 114, 124 that are used may be matched (e.g., to within 0.2) as described in U.S. Pat. No. 9,295,297, entitled “Adhesive Mountable Stack of Removable Layers,” the entire contents of each of which is incorporated by reference herein.

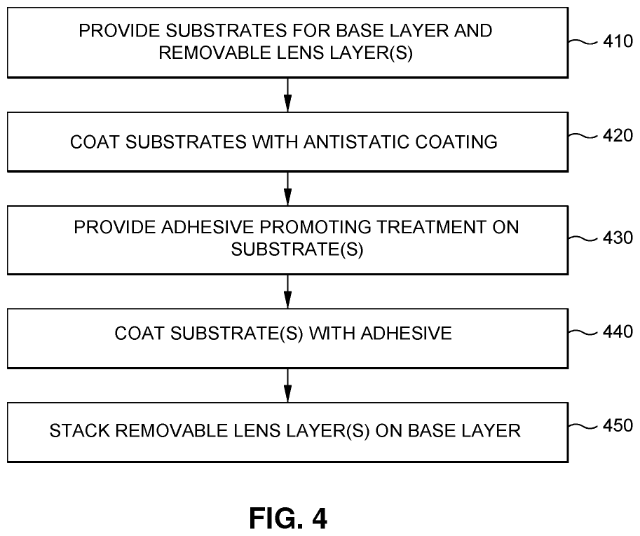

FIG. 4 is an example operational flow according to an embodiment of the present disclosure. The operational flow of FIG. 4 may serve as an example method of manufacturing the removable lens stack 100 described in relation to FIGS. 1-3. The operational flow may begin with providing the substrates 112, 122 to be used in the base layer 110 and each removable lens layer 120 (step 410). The substrates 112, 122, which may be made of PET (e.g., biaxially-oriented PET or BoPET) or TPU as noted above, may be selected for particular modulation transfer function (MTF) data or may be fabricated while actively monitoring the MTF data in a continuous or batch-to-batch process as described in any of U.S. Patent Application Pub. No. 2021/0162645, entitled “Method and Apparatus for Reducing Non-Normal Incidence Distortion in Glazing Films,” U.S. Patent Application Pub. No. 2022/0032591, also entitled “Method and Apparatus for Reducing Non-Normal Incidence Distortion in Glazing Films,” or U.S. Patent Application Pub. No. 2021/0283994, entitled “Protective Barrier for Safety Glazing,” the entire contents of each of which is incorporated by reference herein. In this regard, providing the substrate 112, 122 may include, for example, melting a resin, extruding the melted resin through a die to produce a film, and cooling the film. Examples of TPU films, specifically, may be found in commonly owned U.S. patent application Ser. No. 17/937,371, entitled “Multi-layer Windshield Film having Progressive Thickness Layers,” the entire contents of which is incorporated by reference herein.

Each substrate 112, 122 may be coated with an antistatic coating 116, 126 on one side thereof (step 420). The antistatic coating 116, 126 may comprise an acrylic or urethane polymer with positively charged ions 30 dispersed therein, which may be coated on the substrate by spin coating, dip coating, or vacuum deposition, for example. The ions 30 may be the same as those found in consumer products such as dryer sheets or hair conditioner, for example, but advantageously may be dispersed in a very thin (e.g., 5-10 nm), optically clear coating 116, 126, which may be refractive index matched (e.g., to within 0.2) with the substrate 112, 122 for reduced optical distortion. On the opposite side, each removable lens layer substrate 122 (and optionally the base layer substrate 112) may further be provided with an adhesive promoting treatment 128, 118 (step 430) such as a rough coat of acrylic or polyurethane or a corona treatment, for example, and subsequently coated with an adhesive 124, 114 (step 440), which is preferably wet deposited but may be applied according to any appropriate methods including spin coating, dip coating, or vacuum deposition. The adhesive 114, 124 may be a wet mount adhesive as disclosed, for example, in U.S. Pat. Nos. 9,128,545, 9,274,625, and 10,620,670, all entitled “Touch Screen Shield,” the entire contents of each of which is incorporated by reference herein, or a dry mount adhesive as disclosed, for example, in the above-mentioned '297 patent. The adhesive 114, 124 may be an acrylic or silicon adhesive such as an acrylic pressure sensitive adhesive (PSA) or a silicon PSA and may, in particular, be an optically clear adhesive (OCA).

The operational flow of FIG. 4 may continue with stacking one or more of the resulting lens(es) 120, including substrate(s) 122, adhesive(s) 124, antistatic coating(s) 126, and optional adhesive promoting treatment(s) 128, on the base layer 110 including the substrate 112 and antistatic coating 116 (and in some cases adhesive 114 with optional adhesive promoting treatment 118) to produce a removable lens stack 100 (step 450). Example stacking and adhesive curing processes that may be used in connection with producing the removable lens stack 100 are described in commonly owned U.S. patent application Ser. No. 17/823,413, entitled “Stack of Sterile Peelable Lenses with Low Creep,” the entire contents of which is incorporated by reference herein. If an adhesive 114 is used on the base layer 110, a release liner may be used to protect the adhesive 114 prior to application of the removable lens stack 100 on a face shield or other article. In addition to the substrates 112, 122, adhesive(s) 114, 124, antistatic coating(s) 116, 126, and adhesive promoting treatment(s) 118, 128 described herein, it is contemplated that the base layer 110 and/or each removable lens layer 120 may further include other layers or additives, such as a hard coat as described in the above-mentioned '994 publication, anti-reflective coating(s) as described in U.S. Patent Application Pub. No. 2020/0124768, entitled “Transparent Covering Having Anti-Reflective Coatings,” a thermochromic film as described in U.S. Patent Application Pub. No. 2021/0070017, entitled “Nano Particle Solar Control Film,” a UV blocking layer or additive as described in commonly owned U.S. patent application Ser. Nos. 17/342,373 and 17/938,308, both entitled “Low Haze UV Blocking Removable Lens Stack,” moth eye and/or fluoropolymer coating(s) as described in U.S. Pat. No. 11,307,329, entitled “Low Reflectance Removable Lens Stack,” and/or coatings of differing refractive index as described in U.S. Pat. Nos. 10,427,385 and 11,141,959 and U.S. Patent Application Pub. No. 2021/0402744, entitled “Low Reflectance Optical Web,” the entire contents of each of which is incorporated by reference herein. In order to keep optical distortion as low as possible, the refractive indices of the substrates 112, 122, adhesive(s) 114, 124, antistatic coating(s) 116, 126, adhesive promoting treatment(s) 118, 128, and any other layers or additives within each layer 110, 120 and likewise the refractive indices between each of the layers 110, 120 of the stack 100 may be matched (e.g., to within 0.2) as described in the above-mentioned '297 patent.

In the example of FIGS. 2 and 3, two removable lens layers 120 are shown, which are stacked on the base layer 110 to form the removable lens stack 100. However, it is contemplated that there may be more than two removable lens layers 120 (e.g., three, four, or more) or that there may be only a single removable lens layer 120. It should also be noted that not all removable lens layers 120 need necessarily be identical. For example, the outermost removable lens layer 120 may omit the anti-static coating 126 since, in the case of the outermost layer 120, the increased buildup of static charge caused by the previous removal of a layer 120 is not a concern. It is also contemplated that the removable lens layers 120 may vary in thickness, for example, as described in the above mentioned '371 application, or may have peripheral tabs for easy tear-off that might vary in their position along the periphery of the layers 120. In this regard, an example system that may allow for easy tear-off when the removable lens stack 100 is affixed to a face shield or other article is described in U.S. Patent Application Pub. No. 2022/0304412, entitled “Tearoff Tab Tensioner,” the entire contents of which is incorporated by reference herein.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1-20. (canceled)

21. A sand blasting helmet comprising:
a face shield; and
one or more removable lens layers stacked on the face shield, each removable lens layer including a substrate, an antistatic coating, and an adhesive, the antistatic coating being provided on a first side of the substrate and the adhesive being provided on a second side of the substrate opposite the first side, the one or more removable lens layers being stacked on the face shield such that the second side of the substrate of a first of the one or more removable lens layers faces the face shield and the adhesive provided on the second side of the substrate of each removable lens layer after the first faces and contacts the antistatic coating provided on the first side of the substrate of an immediately preceding removable lens layer from among the one or more removable lens layers.

22. The sand blasting helmet of claim 21, wherein each removable lens layer further includes an adhesive promoting treatment on the second side of the substrate between the substrate and the adhesive.

23. The sand blasting helmet of claim 21, wherein each removable lens layer is corona treated on the second side of the substrate.

24. The sand blasting helmet of claim 21, wherein the substrate of each removable lens layer comprises a polyethylene terephthalate (PET) film.

25. The sand blasting helmet of claim 21, wherein the substrate of each removable lens layer comprises a thermoplastic polyurethane (TPU) film.

26. A method of manufacturing a removable lens stack, the method comprising:
providing an antistatic coating on a first substrate;
comprising quaternary ammonium cations;
providing an adhesive on a second substrate; and
stacking the second substrate on the first substrate such that the adhesive provided on the second substrate faces and contacts the antistatic coating provided on the first substrate.

27. The method of claim 26, further comprising providing an adhesive promoting treatment on the second substrate prior to said providing the adhesive.

28. The method of claim 26, further comprising corona treating the second substrate prior to said providing the adhesive.

29. The method of claim 26, wherein the second substrate comprises a polyethylene terephthalate (PET) film.

30. The method of claim 26, wherein the second substrate comprises a thermoplastic polyurethane (TPU) film.
